(19) United States
(12) Patent Application Publication
(10) Pub. No.: US 2023/0298194 A1
(43) Pub. Date: Sep. 21, 2023

(54) INFORMATION PROCESSING DEVICE, INFORMATION PROCESSING METHOD, AND PROGRAM

(71) Applicant: SONY SEMICONDUCTOR SOLUTIONS CORPORATION, Kanagawa (JP)

(72) Inventor: Hiromasa DOI, Kanagawa (JP)

(73) Assignee: SONY SEMICONDUCTOR SOLUTIONS CORPORATION, Kanagawa (JP)

(21) Appl. No.: 18/002,926

(22) PCT Filed: Jul. 5, 2021
(86) PCT No.: PCT/JP2021/025245

§ 371 Date: Dec. 22, 2022

Related U.S. Application Data
(60) Provisional application No. 63/048,940, filed on Jul. 7, 2020.

(51) Int. Cl. G06T 7/60; G06T 7/70

(52) U.S. Cl. CPC G06T 7/60; G06T 7/70; G06T 2207/20084; G06T 2207/30196

(57) ABSTRACT

The present disclosure relates to an information processing device, an information processing method, and a program capable of more accurately measuring a size of a target._Provided is an information processing device including a processing unit that performs processing using a learned model learned by machine learning on at least a part of an image including at least a depth image acquired by a sensor and information obtained from the image, and measures a size of a target included in the image. The present disclosure can be applied to, for example, a mobile terminal having a sensor.

### TECHNICAL FIELD

The present disclosure relates to an information processing device, an information processing method, and a program, and more particularly, to an information processing device, an information processing method, and a program capable of more accurately measuring a size of a target.

### BACKGROUND ART

As a method of measuring a size of a foot of a user, a method of using a dedicated foot measuring instrument and a method of analyzing and calculating a captured image obtained by imaging the foot have been proposed. Patent Document 1 discloses a technique for calculating a size of a foot on the basis of an actual length ratio calculated using a foot image captured by a portable terminal and the number of pixels between vertical and horizontal sliders.

### CITATION LIST

### Patent Document

Patent Document 1: Japanese Patent No. 6295400

### SUMMARY OF THE INVENTION

### Problems to Be Solved by the Invention

When measuring a size of a target such as a foot of a user, it is required to measure an accurate size.

The present disclosure has been made in view of such a situation, and an object thereof is to enable more accurate measurement of a size of a target.

### Solutions to Problems

An information processing device according to one aspect of the present disclosure is an information processing device including a processing unit that performs processing using a learned model learned by machine learning on at least a part of an image including at least a depth image acquired by a sensor and information obtained from the image, and measures a size of a target included in the image.

An information processing method and a program according to one aspect of the present disclosure are an information processing method and a program corresponding to the information processing device according to one aspect of the present disclosure.

In the information processing device, the information processing method, and the program according to one aspect of the present disclosure, processing using a learned model learned by machine learning is performed on at least a part of an image including at least a depth image acquired by a sensor and information obtained from the image, and a size of a target included in the image is measured.

Note that the information processing device according to one aspect of the present disclosure may be an independent device or an internal block constituting one device.

### BRIEF DESCRIPTION OF DRAWINGS

FIG. 1 is a block diagram illustrating a configuration example of an information processing device to which the present disclosure is applied.

FIG. 2 is a block diagram illustrating a first example of a configuration of a processing unit in FIG. 1.

FIG. 3 is a flowchart illustrating a first example of a flow of a foot length measuring process.

FIG. 4 is a diagram schematically illustrating a flow of data in the foot length measuring process of FIG. 3.

FIG. 5 is a block diagram illustrating a second example of a configuration of a processing unit in FIG. 1.

FIG. 6 is a flowchart illustrating a second example of a flow of a foot length measuring process.

FIG. 7 is a diagram schematically illustrating a flow of data in the foot length measuring process of FIG. 6.

FIG. 8 is a block diagram illustrating a third example of a configuration of a processing unit in FIG. 1.

FIG. 9 is a flowchart illustrating a third example of a flow of a foot length measuring process.

FIG. 10 is a diagram schematically illustrating a flow of data in the foot length measuring process of FIG. 9.

FIG. 11 is a diagram illustrating an example of a development workflow and a platform for providing an application executed by the information processing device to which the present disclosure is applied.

FIG. 12 is a flowchart illustrating a flow of a shoe try-on purchase process.

FIG. 13 is a diagram illustrating a first example of display of a foot length measuring application.

FIG. 14 is a diagram illustrating a second example of display of a foot length measuring application.

FIG. 15 is a diagram illustrating a third example of display of a foot length measuring application.

FIG. 16 is a diagram illustrating a fourth example of display of a foot length measuring application.

FIG. 17 is a diagram illustrating a configuration example of a system including a device that performs AI processing.

FIG. 18 is a block diagram illustrating a configuration example of an electronic device.

FIG. 19 is a block diagram illustrating a configuration example of an edge server or a cloud server.

FIG. 20 is a block diagram illustrating a configuration example of an optical sensor.

FIG. 21 is a block diagram illustrating a configuration example of a processing unit.

FIG. 22 is a diagram illustrating a flow of data between a plurality of devices.

### MODE FOR CARRYING OUT THE INVENTION

### 1. First Embodiment

### (Configuration Example of Device)

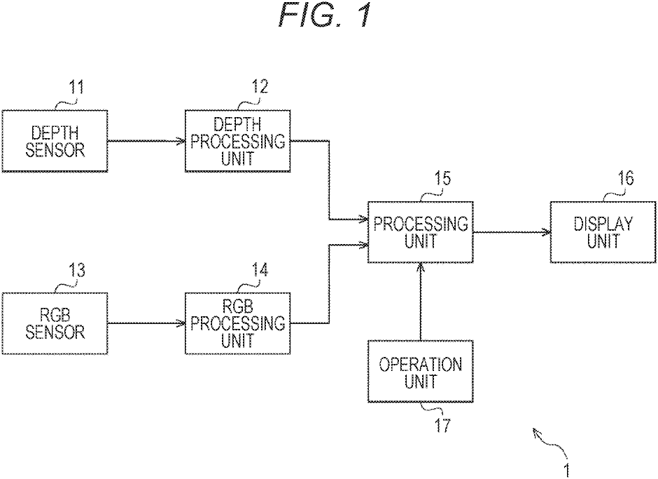

FIG. 1 is a block diagram illustrating a configuration example of an information processing device to which the present disclosure is applied.

An information processing device 1 has a function of measuring a size of a target by using captured image data. The information processing device 1 is configured as a mobile terminal such as a smartphone, a tablet terminal, or a mobile phone. As the size of the target, the size of the foot of the user carrying the mobile terminal can be measured.

In FIG. 1, the information processing device 1 includes a depth sensor 11, a depth processing unit 12, an RGB sensor 13, an RGB processing unit 14, a processing unit 15, a display unit 16, and an operation unit 17.

The depth sensor 11 is a distance measuring sensor such as a time of flight (ToF) sensor. The ToF sensor may use either a direct time of flight (dToF) method or an indirect time of flight (iToF) method. The depth sensor 11 measures the distance to the target and supplies a distance measurement signal obtained as a result to the depth processing unit 12. Note that the depth sensor 11 may be a structure light type sensor, a light detection and ranging (LiDAR) type sensor, a stereo camera, or the like.

The depth processing unit 12 is a signal processing circuit such as a digital signal processor (DSP). The depth processing unit 12 performs signal processing such as depth development processing or depth preprocessing (for example, resizing processing or the like), on the distance measurement signal supplied from the depth sensor 11, and supplies depth image data obtained as a result to the processing unit 15. The depth image is an image indicating a target by depth information. For example, a depth map is used as the depth image. Note that the depth processing unit 12 may be included in the depth sensor 11.

The RGB sensor 13 is an image sensor such as a complementary metal oxide semiconductor (CMOS) image sensor or a charge coupled device (CCD) image sensor. The RGB sensor 13 captures a target image and supplies an imaging signal obtained as a result to the RGB processing unit 14. Note that not only an RGB camera using the RGB sensor 13 but also a monochrome camera, an infrared camera, or the like may be used to capture a target image.

The RGB processing unit 14 is a signal processing circuit such as a DSP. The RGB processing unit 14 performs signal processing such as RGB development processing or RGB preprocessing (for example, resizing processing or the like), on the imaging signal supplied from the RGB sensor 13, and supplies RGB image data obtained as a result to the processing unit 15. The RGB image is an image indicating a target image by color information (surface information). For example, a color camera image is used as the RGB image. Note that the RGB processing unit 14 may be included in the RGB sensor 13.

The processing unit 15 includes a processor such as a central processing unit (CPU). The depth image data from the depth processing unit 12 and the RGB image data from the RGB processing unit 14 are supplied to the processing unit 15.

The processing unit 15 performs a length measuring process of measuring the size of the target on the basis of the depth image data and the RGB image data. In a case where the foot length measuring process of measuring the foot size of the user as the size of the target is performed, the depth image and the RGB image include the foot (ahead of the ankle) of the user as the subject. Note that, in the length measuring process, at least one image of the depth image or the RGB image is used, and it is not always necessary to use both images.

In the length measuring process, processing using a learned model learned by machine learning is performed on at least a part of depth image data, RGB image data, and information obtained from the image data, and the size of the target is measured. The size of the target measured in the length measuring process is supplied to the display unit 16.

The display unit 16 includes a panel such as a liquid crystal panel or an organic light emitting diode (OLED) panel, a signal processing circuit, and the like. The display unit 16 displays information such as the size of the target supplied from the processing unit 15.

The operation unit 17 includes a physical button, a touch panel, or the like. The operation unit 17 supplies an operation signal corresponding to an operation of the user to the processing unit 15. The processing unit 15 performs various types of processing on the basis of the operation signal from the operation unit 17.

Note that the configuration of the information processing device 1 illustrated in FIG. 1 is an example, and components may be deleted or other components may be added. For example, in a case where only the depth image is used in the length measuring process in the processing unit 15, it is not necessary to provide the RGB sensor 13 and the RGB processing unit 14. Furthermore, the information processing device 1 can be provided with a communication unit for exchanging data with a server on the Internet, a storage unit for recording various data, programs, and the like, an input unit such as a microphone, an output unit such as a speaker, and the like.

### (Configuration Example of Processing Unit)

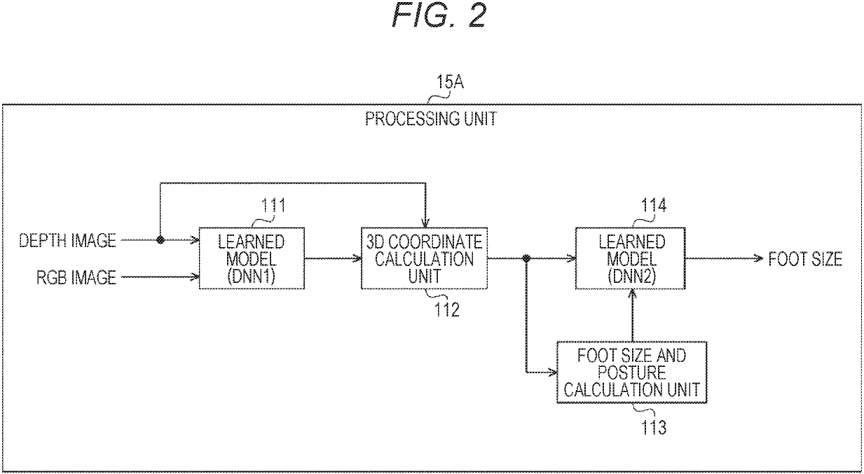

FIG. 2 is a block diagram illustrating a first example of the configuration of the processing unit 15 in FIG. 1.

In FIG. 2, a processing unit 15A includes a learned model 111, a 3D coordinate calculation unit 112, a foot size and posture calculation unit 113, and a learned model 114. The processing unit 15A measures the foot size of the user as the size of the target.

The learned model 111 is a model that has been learned by performing learning using a deep neural network (DNN) at the time of learning. By using the learned model 111 at the time of inference, it is possible to predict 2D feature points regarding the foot from the depth image or the RGB image.

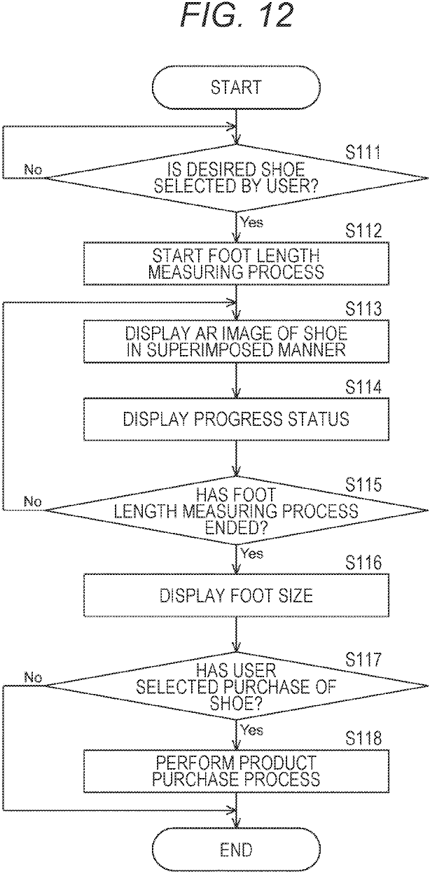

Hereinafter, the learned model 111 learned using the deep neural network is also referred to as a DNN 1 in order to be distinguished from other learned models. The learning of the DNN 1 will be described later with reference to FIG. 11.

The depth image or the RGB image obtained by imaging the foot of the user is supplied to the processing unit 15A as measurement data, and is input to the learned model 111. In the processing unit 15A, by performing inference using the learned model 111 using the depth image or the RGB image as an input, 2D feature points regarding the foot are output.

For example, the 2D feature points includes at least three feature points of a fingertip (tip), a base of thumb, and a heel (heal). The 2D feature points are represented by 2D coordinates. By increasing the number of 2D feature points, measurement accuracy can be improved.

The 2D feature points output from the learned model 111 are supplied to the 3D coordinate calculation unit 112. Furthermore, the depth image as the measurement data is supplied to the 3D coordinate calculation unit 112.

Here, in a case where the depth image is input to the learned model 111, the same depth image is supplied to the 3D coordinate calculation unit 112. On the other hand, in a case where the RGB image is input to the learned model 111, the depth image captured at substantially the same timing as the RGB image is supplied to the 3D coordinate calculation unit 112.

The 3D coordinate calculation unit 112 calculates 3D coordinates corresponding to the 2D feature points using the depth image and unique parameters. Specifically, a point cloud that is a set of 3D coordinates (x, y, z) is generated from the depth image using the camera parameters at the time of imaging. By using this point cloud, it is possible to acquire the coordinates (x, y, z) of the 3D feature point corresponding to the coordinates (X, Y) of the 2D feature point regarding the foot.

The 3D feature points calculated by the 3D coordinate calculation unit 112 are supplied to the foot size and posture calculation unit 113 and the learned model 114.

The foot size and posture calculation unit 113 calculates the size (foot size) and posture (pose) of the foot of the user by using information such as 3D feature points.

Examples of the foot size include a foot length (length) which is a length from the heel to the fingertip, a foot width (width) which is a length from the base of the thumb to the base of the little finger, a foot height (height) which is a height from the ground to the top, and the like. Hereinafter, a case where the foot length is calculated as the foot size will be described.

Furthermore, in calculating the foot size, in a state in which a joint of a toe is bent (a state in which a finger is folded), a state in which a tip of a toe or a heel is hidden, or the like, the value is not accurate even if the foot size is calculated as it is. Therefore, here, the foot posture is calculated in order to consider these states. The foot posture is represented by a vector or the like representing a position in the space in the camera coordinate system.

The foot size and the foot posture calculated by the foot size and posture calculation unit 113 are supplied to the learned model 114.

The learned model 114 is a model that has been learned by performing learning using a deep neural network at the time of learning. By using the learned model 114 at the time of inference, the corrected foot size can be predicted from the 3D feature points, the foot size, and the foot posture.

Hereinafter, the learned model 114 learned using the deep neural network is also referred to as a DNN 2 in order to be distinguished from other learned models. The learning of the DNN 2 will be described later with reference to FIG. 11.

The 3D feature points from the 3D coordinate calculation unit 112 and the foot size and foot posture from the foot size and posture calculation unit 113 are supplied to the learned model 114. The processing unit 15A outputs the corrected foot size by performing inference using the learned model 114 using the 3D feature points, the foot size, and the foot posture as inputs.

For example, in a case where the joint of the toe is in a bent state, the correct foot size is not obtained even if the length from the fingertip to the heel is calculated. However, in the learned model 114, since the information is input as the foot posture, the input foot size can be corrected to the foot size in a state where the joint of the toe is not bent, and the foot size after correction can be output.

User information and other measurement results may be input to the learned model 114. For example, the user information can include information regarding the user to be measured, such as gender and age. Other measurement results can include a measurement result of foot size other than foot length (for example, the measurement result of the length of the toe). By adding the user information and the like to the input, the accuracy rate (accuracy) of the prediction result by the learned model 114 can be further improved.

In the learned model 114, in a case where the difference between the values of the input and the output, that is, the difference between the foot size value before correction and the foot size value after correction exceeds a predetermined threshold, the foot size value after correction may not be used as the prediction result. That is, the data such as the depth image and the 3D feature points includes an error, and in a case where the difference between the values of the input and the output is large, there is a high possibility that the value is an erroneous value. Therefore, the prediction results are collected in the time direction, and the outlier is removed.

For example, in the information processing device 1, the depth image and the RGB image are acquired at predetermined time intervals, and the foot length measuring process can be executed according to the timing at which these images are acquired. However, since the foot size after correction can be obtained from the prediction result excluding the outlier, the measurement accuracy of the foot size can be improved.

The foot size after correction output from the learned model 114 is supplied to the display unit 16. The processing unit 15A may perform predetermined processing on the foot size after correction, and then supply the foot size after correction to the display unit 16. The display unit 16 displays information corresponding to the foot size after correction supplied from the processing unit 15A.

In the processing unit 15A configured as described above, the processing using the learned model 111 as the DNN 1 is performed on the depth image or the RGB image, and the processing using the learned model 114 as the DNN 2 is performed on the 3D feature points, the foot size, and the foot posture obtained by processing the depth image or the RGB image, so that the corrected foot size is obtained.

As described above, in measuring the size of the target, inference using the learned models that are the DNN 1 and the DNN 2 is performed, and thus, it is possible to measure a more accurate size as the prediction accuracy of the learned model is improved. Furthermore, since the posture of the target is taken into consideration when the inference using the DNN 2 is performed, the accurate size can be measured even if the target is not in a state suitable for measuring the size.

Moreover, the accuracy rate of the prediction result can be improved by adding user information, other measurement results, and the like as the input of the DNN 2. Furthermore, in a case where the difference between the values of the input and the output of the DNN 2 is large, it is possible to further improve the measurement accuracy by excluding the difference from the prediction result as an outlier.

### (Flow of Foot Length Measuring Process)

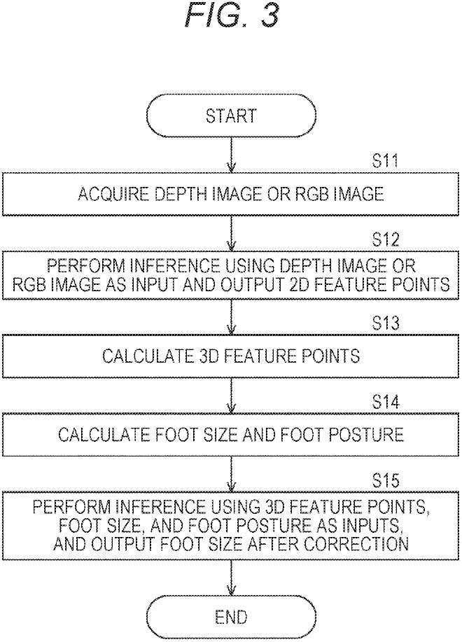

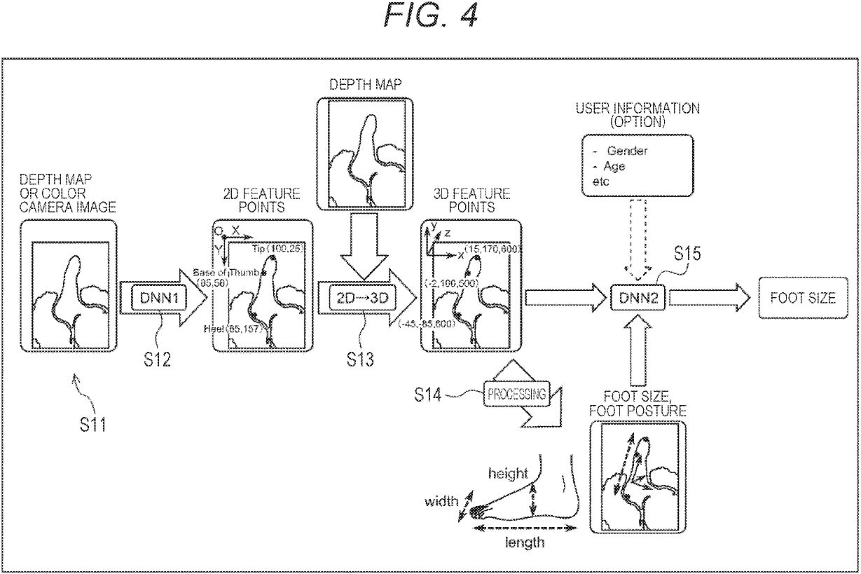

Next, a flow of the foot length measuring process executed by the processing unit 15A in FIG. 2 will be described with reference to a flowchart in FIG. 3. FIG. 4 schematically illustrates a flow of data in the foot length measuring process illustrated in FIG. 3, and will be described with appropriate reference.

The processing of the flowchart of FIG. 3 is started when the user performs imaging with the information processing device 1 such as a mobile terminal facing his/her foot.

In step S11, the processing unit 15A acquires the depth image from the depth processing unit 12 or the RGB image from the RGB processing unit 14. For example, a depth map is acquired as the depth image, or a color camera image is acquired as the RGB image (S11 in FIG. 4).

In step S12, the processing unit 15A performs inference using the acquired depth image or RGB image as an input using the learned model 111, thereby outputting the 2D feature points. For example, by performing inference using a depth map or a color camera image as an input using the learned model 111 learned as the DNN 1, the coordinates (100, 25) of the fingertip (tip), the coordinates (85, 58) of the base of the thumb, and the coordinates (65, 157) of the heel (heal) are output as the 2D feature points (S12 in FIG. 4).

In step S13, the 3D coordinate calculation unit 112 calculates 3D feature points corresponding to the 2D feature points. For example, a point cloud that is a set of 3D coordinates (x, y, z) can be generated from the depth map using camera parameters at the time of imaging (information regarding the viewing angle of the depth sensor 11, and the like). Using this point cloud, the coordinates (15, 170, 600) of the fingertip, the coordinates (-2, 100, 500) of the base of the thumb, and the coordinates (-45, 85, 600) of the heel are obtained as 3D feature points corresponding to the 2D feature points (S13 in FIG. 4).

In step S14, the foot size and posture calculation unit 113 calculates the foot size and the foot posture. For example, as the foot size, the foot length (length) is calculated by performing calculation using the 3D coordinates of the fingertip and the heel of the foot (S14 in FIG. 4). As the foot posture (pose), information indicating that the joint of the toe is in a bent state or the tip or heel of the toe is in a hidden state is calculated by performing calculation using information such as 3D feature points or the like (S14 in FIG. 4). For example, the foot posture is represented by a 3D vector in the camera coordinate system.

In step S15, the processing unit 15A performs inference using the 3D feature points, the foot size, and the foot posture as inputs using the learned model 114, thereby outputting the foot size after correction. For example, when 3D feature points (3D coordinates), a foot size (distance) that is a foot length, and a foot posture (3D vector) indicating that a joint of a toe is in a bent state are input using the learned model 114 learned as the DNN 2, the input foot length is corrected to the foot length in a state where the joint of the toe is not bent, and the foot length after correction (foot size) is output (S15 in FIG. 4).

As described above, when the joint of the toe is in a bent state or the tip or heel of the toe is in a hidden state or the like, the foot size measured in these states is not an accurate value. Therefore, by inputting the foot posture to the learned model 114, the foot size corrected for measurement in an ideal state is output as an output. Furthermore, user information (option user information in FIG. 4) such as gender and age, and other measurement results such as the length of the toe are input to the learned model 114, whereby the accuracy rate of the prediction result can be improved. Note that the user operates the application started by the information processing device 1, whereby the user information of the user can be registered in advance.

Furthermore, in the foot length measuring process, the foot size after correction can be obtained every time the depth image or the RGB image is acquired. Therefore, every time the foot size after correction is obtained, the foot size is compared with the foot size before the correction, and in a case where the difference is large, the foot size is removed as an outlier. As a result, since the foot size from which the outlier is finally removed is obtained, the measurement accuracy of the foot size can be improved.

Note that, in the processing of step S12, an example of obtaining the 2D feature points from the depth image or the RGB image has been described. However, since the depth image has a smaller amount of information than the RGB image, the calculation amount at the time of processing can be reduced in the case of using the depth image.

As described above, in the foot length measuring process, the process using the learned model 111 learned as the DNN 1 and the learned model 114 learned as the DNN 2 is performed, so that the corrected foot size is obtained from the image such as the depth image obtained by imaging the foot of the user. Therefore, as the prediction accuracy of the learned models (DNN 1 and DNN 2) is improved, the foot size can be measured more accurately. Furthermore, in the foot length measuring process, the corrected foot size can be obtained only by inputting an image such as a depth image, and thus the foot size can be measured more quickly as the processing capability of the processing unit 15A is improved.

### 2. Second Embodiment

In the above description, the configuration and the flow of processing in a case where 2D feature points are output by using the learned model 111 learned as the DNN 1 in the processing unit 15 of FIG. 1 have been described. However, 3D feature points may be output. Next, a configuration and a flow of processing in a case where the output of the learned model in the previous stage is 3D feature points in the processing unit 15 of FIG. 1 will be described.

### (Configuration Example of Processing Unit)

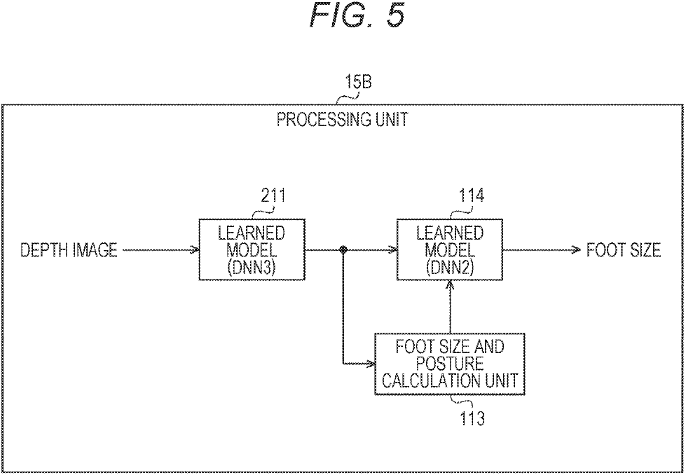

FIG. 5 is a block diagram illustrating a second example of the configuration of the processing unit 15 in FIG. 1.

In FIG. 5, a processing unit 15B includes a learned model 211, a foot size and posture calculation unit 113, and a learned model 114. The processing unit 15B measures the foot size of the user as the size of the target.

In the processing unit 15B, portions corresponding to the processing unit 15A (FIG. 2) are denoted by the same reference numerals. That is, in the processing unit 15B, the learned model 211 is provided instead of the learned model 111 and the 3D coordinate calculation unit 112 as compared with the processing unit 15A.

The learned model 211 is a model that has been learned by performing learning using a deep neural network at the time of learning. By using the learned model 211 at the time of inference, it is possible to predict 3D feature points regarding the foot from the depth image.

Hereinafter, the learned model 211 learned using the deep neural network is also referred to as a DNN 3 in order to be distinguished from other learned models. The learning of the DNN 3 will be described later with reference to FIG. 11.

The depth image obtained by imaging the foot of the user is supplied to the processing unit 15B as measurement data, and is input to the learned model 211. The processing unit 15B outputs the 3D feature points regarding the foot by performing inference using the learned model 211 using the depth image as an input. For example, the 3D feature points include at least three feature points of a fingertip, a base of a thumb, and a heel. The 3D feature points are represented by 3D coordinates.

The 3D feature points output from the learned model 211 are supplied to the foot size and posture calculation unit 113 and the learned model 114. The description of the foot size and posture calculation unit 113 and the learned model 114 will be repeated, and thus, will be appropriately omitted.

The foot size and posture calculation unit 113 calculates the foot size and the foot posture on the basis of information such as 3D feature points. The processing unit 15B outputs the corrected foot size by performing inference using the learned model 114 using the 3D feature points, the foot size, and the foot posture as inputs.

In the processing unit 15B configured as described above, the processing using the learned model 211 as the DNN 3 is performed on the depth image, and the processing using the learned model 114 as the DNN 2 is performed on the 3D feature points, the foot size, and the foot posture obtained by processing the depth image, so that the corrected foot size is obtained. That is, as compared with the processing unit 15A (FIG. 2), the processing unit 15B directly obtains the 3D feature points instead of the 2D feature points by using the learned model in the previous stage using the image as the input.

As described above, in measuring the size of the target, inference using the learned models that are the DNN 3 and the DNN 2 is performed, and thus, it is possible to measure a more accurate size as the prediction accuracy of the learned model is improved. Furthermore, since the posture of the target is taken into consideration when the inference using the DNN 2 is performed, the accurate size can be measured even if the target is not in a state suitable for measuring the size.

### (Flow of Foot Length Measuring Process)

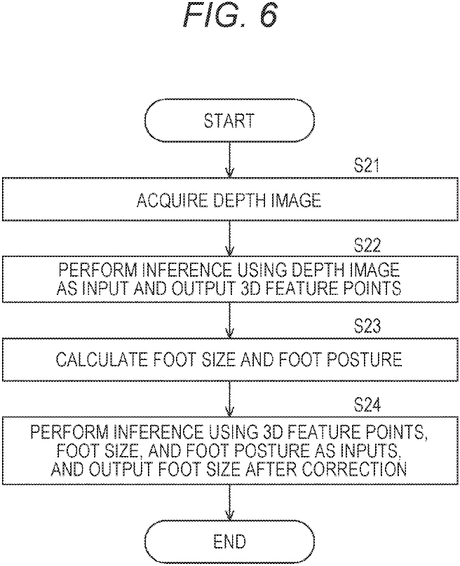

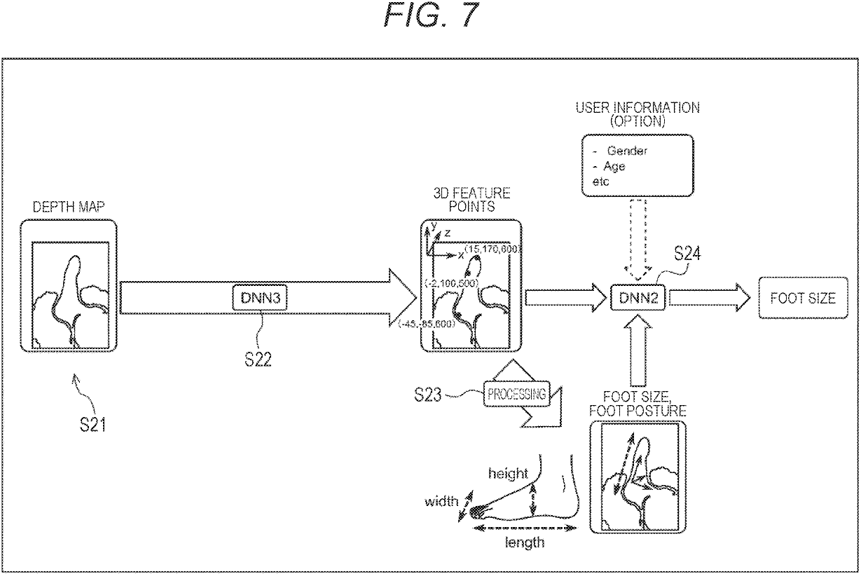

Next, a flow of the foot length measuring process executed by the processing unit 15B in FIG. 5 will be described with reference to a flowchart in FIG. 6. FIG. 7 schematically illustrates a flow of data in the foot length measuring process illustrated in FIG. 6, and will be described with appropriate reference.

The processing of the flowchart of FIG. 6 is started when the user performs imaging with the information processing device 1 such as a mobile terminal facing his/her foot.

In step S21, the processing unit 15B acquires the depth image from the depth processing unit 12. For example, a depth map is acquired as the depth image (S21 in FIG. 7).

In step S22, the processing unit 15B performs inference using the acquired depth image as an input using the learned model 211, thereby outputting the 3D feature points. For example, by performing inference using a depth map as an input using the learned model 211 learned as the DNN 3, the coordinates (15, 170, 600) of the fingertip, the coordinates (-2, 100, 500) of the base of the thumb, and the coordinates (-45, 85, 600) of the heel are output as 3D feature points (S22 in FIG. 7).

In steps S23 to S24, similarly to steps S14 to S15 in FIG. 3 described above, the foot size and the foot posture are calculated by the foot size and posture calculation unit 113, and inference is performed using the 3D feature points, the foot size, and the foot posture as inputs using the learned model 114 learned as the DNN 2, and the foot size after correction is output (S23 and S24 in FIG. 7).

As described above, in the foot length measuring process, the process using the learned model 211 learned as the DNN 3 and the learned model 114 learned as the DNN 2 is performed, so that the corrected foot size is obtained from the depth image obtained by imaging the foot of the user. Therefore, as the prediction accuracy of the learned models (DNN 3 and DNN 2) is improved, the foot size can be measured more accurately.

### 3. Third Embodiment

In the above description, the configuration and the flow of processing in a case where two learned models are used in the processing unit 15 of FIG. 1 have been described, but the number of learned models may be one. Next, a configuration and a flow of processing in a case where one learned model is used and the corrected foot size is output in the processing unit 15 of FIG. 1 will be described.

### (Configuration Example of Processing Unit)

FIG. 8 is a block diagram illustrating a third example of the configuration of the processing unit 15 in FIG. 1.

In FIG. 8, the processing unit 15C includes a learned model 311. The processing unit 15C measures the foot size of the user as the size of the target.

The learned model 311 is a model that has been learned by the deep neural network at the time of learning. By using the learned model 311 at the time of inference, it is possible to predict the corrected foot size from the depth image.

Hereinafter, the learned model 311 learned using the deep neural network is also referred to as a DNN 4 in order to be distinguished from other learned models. The learning of the DNN 4 will be described later with reference to FIG. 11.

A depth image obtained by imaging the foot of the user is supplied to the processing unit 15C as measurement data, and is input to the learned model 311. The processing unit 15C outputs the corrected foot size by performing inference using the learned model 311 using the depth image as an input.

For example, when the joint of the toe of the user is in a bent state or the like, the foot size predicted from the depth image does not have an accurate value. Therefore, in the learned model 311, the feature such as the foot posture is learned at the time of learning, so that the foot size corrected for measurement in an ideal state (a state where the joint of the toe is not bent) is output.

Note that, in the configuration of the processing unit 15C illustrated in FIG. 8, the case where the depth image is input to the learned model 311 has been illustrated, but an RGB image may be input.

In the processing unit 15C configured as described above, the processing using the learned model 311 as the DNN 4 is performed on the depth image, so that the corrected foot size is obtained. As described above, in measuring the size of the target, inference using the learned model that is the DNN 4 is performed, and thus, it is possible to measure a more accurate size as the prediction accuracy of the learned model is improved.

### (Flow of Foot Length Measuring Process)

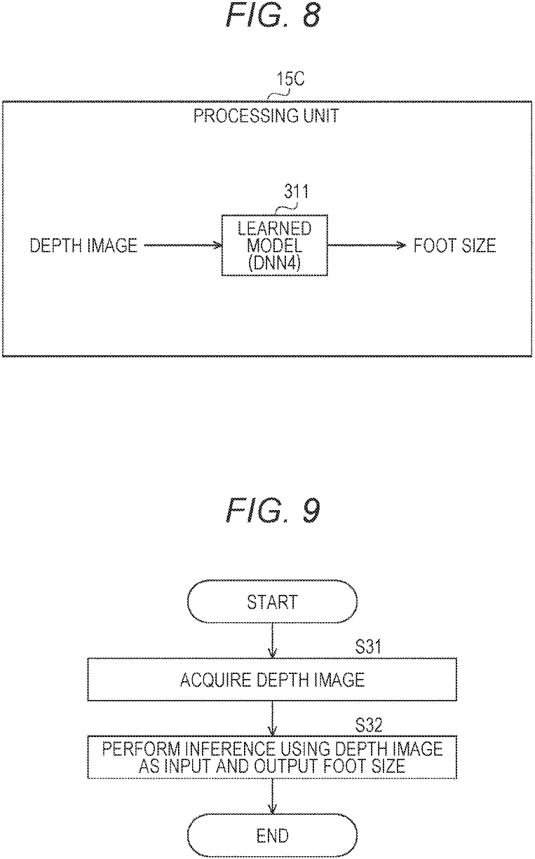

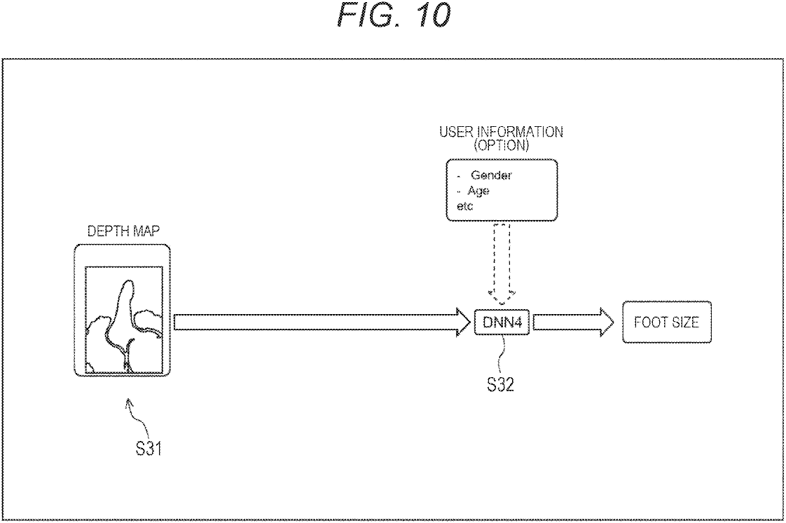

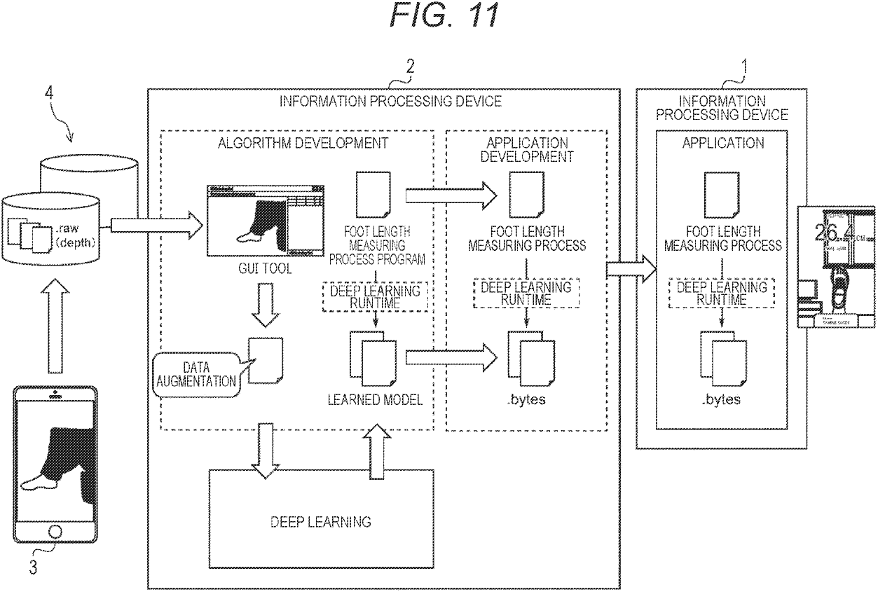

Next, a flow of the foot length measuring process executed by the processing unit 15C in FIG. 8 will be described with reference to a flowchart in FIG. 9. FIG. 10 schematically illustrates a flow of data in the foot length measuring process illustrated in FIG. 9, and will be described with appropriate reference.

The processing of the flowchart of FIG. 9 is started when the user performs imaging with the information processing device 1 such as a mobile terminal facing his/her foot.

In step S31, the processing unit 15C acquires the depth image from the depth processing unit 12. For example, a depth map is acquired as the depth image (S31 in FIG. 10).

In step S32, the processing unit 15C performs inference using the acquired depth image as an input using the learned model 311, thereby outputting the corrected foot size. For example, when the joint of the toe of the user is in a bent state or the like at the time of imaging with the mobile terminal, the foot size corrected for measurement in an ideal state is output (S32 in FIG. 10).

As described above, in the foot length measuring process, the process using the learned model 311 learned as the DNN 4 is performed, so that the corrected foot size is obtained from the depth image obtained by imaging the foot of the user. Therefore, as the prediction accuracy of the learned model (DNN 4) is improved, the foot size can be measured more accurately.

Note that the learned model 311 is learned so as to output the corrected foot size as an output when the depth image is input, but at the time of learning, learning may be performed by not only inputting learning data to the DNN 4 but also giving correct data in the middle of the DNN 4.

### 4. Development Workflow/Platform

FIG. 11 is a diagram illustrating an example of a development workflow and a platform for providing an application executed by the information processing device to which the present disclosure is applied.

In FIG. 11, an application developed using an information processing device 2 such as a personal computer (PC) is provided to and installed in the information processing device 1 such as a mobile terminal.

In the information processing device 2, algorithm development and application development are performed. In the algorithm development, a program of a foot length measuring process (foot measure code) and a learned model (trained model) called when the foot length measuring process is executed are developed.

In the algorithm development, a learned model learned by machine learning using learning data is generated. The information processing device 2 can acquire a large amount of learning data by accumulating the depth images captured by an imaging device 3 that has activated the application for imaging in a database 4. Note that the learning data can include an RGB image.

In the information processing device 2, annotation work is performed on the learning data. For example, the developer labels the feature point (for example, correct feature points such as a fingertip and a heel) in the specific portion of the foot included in the depth image as the learning data using a GUI tool (GUI labeling tool), whereby the teacher data is generated.

Furthermore, data augmentation is performed, and, for example, by enlarging an existing image or horizontally inverting the image, variations of learning data used in machine learning can be increased. As a result, information that cannot be covered only by imaging by the imaging device 3 can be added.

In the information processing device 2, a learned model is generated by performing machine learning by deep learning using learning data. For example, any one of the DNN 1 to the DNN 4 described above can be generated as the learned model.

More specifically, in the DNN 1, when the depth image or the RGB image is input, it is expected that the 2D feature points of the fingertip and the like are output as the output, but the feature points of the portions different from the fingertip and the like are output at the initial stage of learning. Here, by labeling the correct 2D feature points and repeating the learning, the correct 2D feature points such as the fingertip are output, and the learning of the DNN 1 converges.

Similarly, in the DNN 3, when the depth image is input, it is expected to output the 3D feature points as the output. Therefore, by labeling the correct 3D feature points and repeating learning, the correct 3D feature points are output.

Furthermore, in the DNN 2, when the 3D feature points, the foot size, and the foot posture are input, it is expected that the corrected foot size is output as the output. Therefore, by repeating the learning regarding the features of human foot, the correct foot size is output. In the DNN 4, when the depth image is input, it is expected that the corrected foot size is output as the output. Therefore, by repeating the learning regarding the features of human foot, the correct foot size is output.

Note that, in the DNN 2 or the DNN 4, in a case where user information or other measurement results are input, learning is performed in consideration of the information. Furthermore, when learning the learned model, learning may be performed by not only inputting learning data to the DNN but also giving correct data in the middle of the DNN.

It is possible to improve the prediction accuracy of the learned model (DNN 1, DNN 2, and the like) by preparing more learning data or labeled data or increasing the variation of the learning data by data augmentation to perform machine learning. Note that it is desirable to use a high-performance PC as the information processing device 2.

The learned model (DNN 1, DNN 2, or the like) generated in this manner is appropriately called at the time of execution of the foot length measuring process, and outputs a prediction result for the input.

In the application development, an application (hereinafter, also referred to as a foot length measuring application) using the foot size obtained by the foot length measuring process is developed using the program of the foot length measuring process developed by the algorithm development and the learned model. The foot length measuring application developed in this manner is provided to and installed in the information processing device 1 via a server on the Internet or the like.

In the information processing device 1, when the foot length measuring application is activated and the foot of the user (ahead of the ankle) is imaged, the foot length measuring process is executed and the foot size is displayed. In the foot length measuring application, at the time of execution of the foot length measuring process, a learned model such as the DNN 1 or the DNN 2 is appropriately called to obtain a prediction result for the input as an output, and thus, processing using the output is performed.

Note that, although FIG. 11 illustrates a case where the algorithm development and the application development are performed by the same information processing device 2 such as one PC, the algorithm development and the application development may be performed by different information processing devices. Furthermore, each of the algorithm development and the application development may be performed by a plurality of information processing devices.

Furthermore, FIG. 11 illustrates a case where the learning is performed using the teacher data when the learned model is generated in the algorithm development, but the learning may be performed without the teacher data.

### 5. Use Case

Various services can be provided by the foot length measuring application. For example, by using augmented reality (AR) technology, it is possible to try on shoes according to the foot size of the user (so-called AR try-on), and in a case where the user likes the shoes, it is possible to provide a purchasable service using electronic commerce (EC).

### (Shoe Try-On Purchase Process)

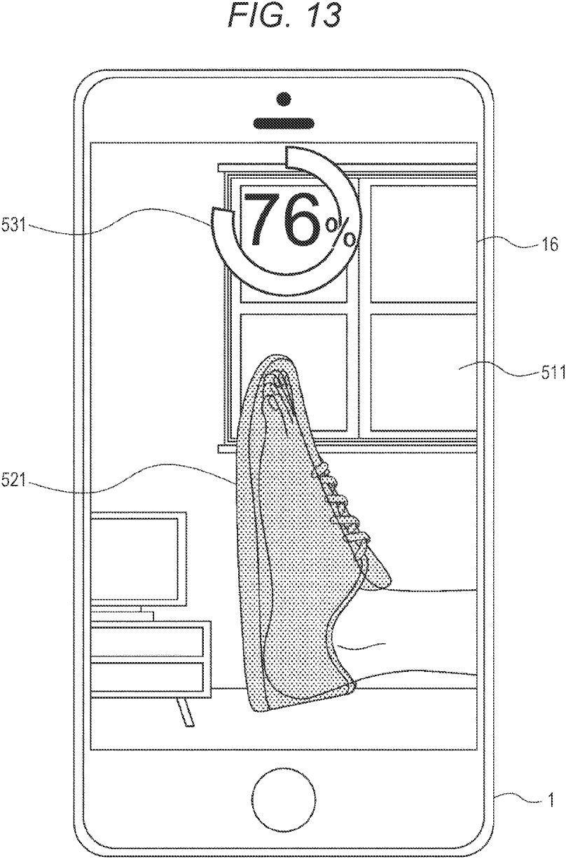

A flow of a shoe try-on purchase process executed by the information processing device 1 will be described with reference to a flowchart of FIG. 12.

In the information processing device 1, the foot length measuring application is activated when the shoe try-on purchase process is executed.

In step S111, the processing unit 15 determines whether or not a desired shoe is selected by the user on the basis of the operation signal from the operation unit 17. In a case where it is determined in step S111 that the desired shoe is selected by the user, the process proceeds to step S112.

In step S112, the processing unit 15 starts the foot length measuring process. At the start of the foot length measuring process, the user directs the information processing device 1 toward his/her foot (ahead of the ankle), so that the foot of the user is imaged (measured) by the depth sensor 11 and the RGB sensor 13.

In the foot length measuring process, the process described in any one of the three embodiments described above is performed. That is, the processing using the learned models of the DNN 1 and the DNN 2, the DNN 3 and the DNN 2, or the DNN 4 is performed on at least a part of the image including the depth image and the information obtained from the image.

In step S113, the processing unit 15 superimposes the AR image of the selected shoe on the foot of the user included in the captured RGB image and displays the AR image on the display unit 16.

In step S114, the processing unit 15 displays, on the display unit 16, the progress status in conjunction with a variation in the posture of the foot, the imaging time, the time required for the foot length measuring process, and the like.

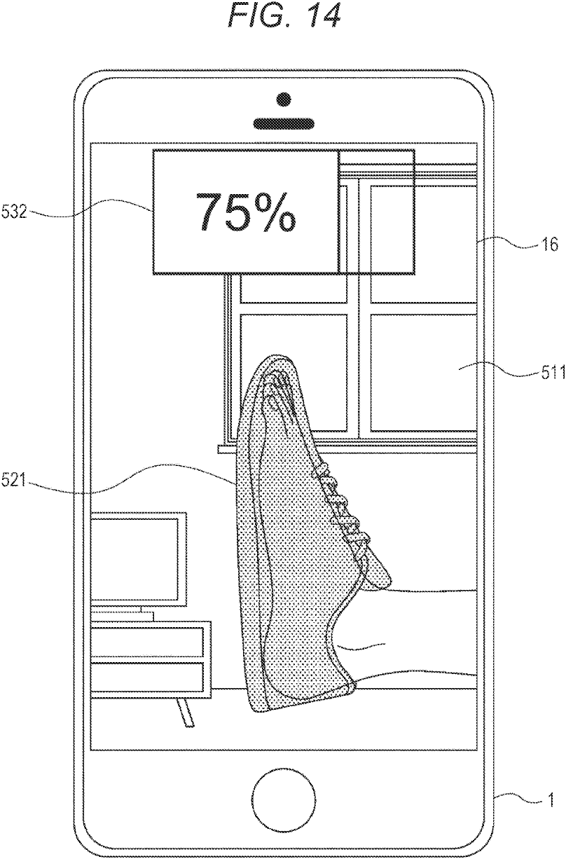

For example, as illustrated in FIG. 13, in the display unit 16 of the information processing device 1, the AR image 521 of the shoe selected by the user is superimposed and displayed on the portion of the foot of the user included in the imaging screen 511 according to the captured RGB image. Note that a known technique can be used for superimposing display of the AR image. Since the posture of the foot and the like can be recognized in the foot length measuring process, the image marker (AR marker) is unnecessary.

Furthermore, the progress status 531 is displayed on the imaging screen 511. The foot length measuring process is performed while the user is performing the AR try-on of the shoe. That is, in the foot length measuring process, since the foot size is calculated and the process of removing the outlier from the value sequentially obtained in the time direction or the like is performed, a certain time is required, but the progress considering the time is presented.

In the method of presenting the progress, the progress may be represented by a ratio of a donut-shaped graph as in the progress status 531 in FIG. 13, or may be represented by a ratio of a horizontal bar-shaped graph as in the progress status 532 in FIG. 14, for example. Note that the display of the progress status is not limited to the donut-shaped or horizontal bar-shaped graph, and other display forms may be used. Moreover, a method of presenting the progress is not limited to display, and other presentation methods such as sound output and vibration may be used.

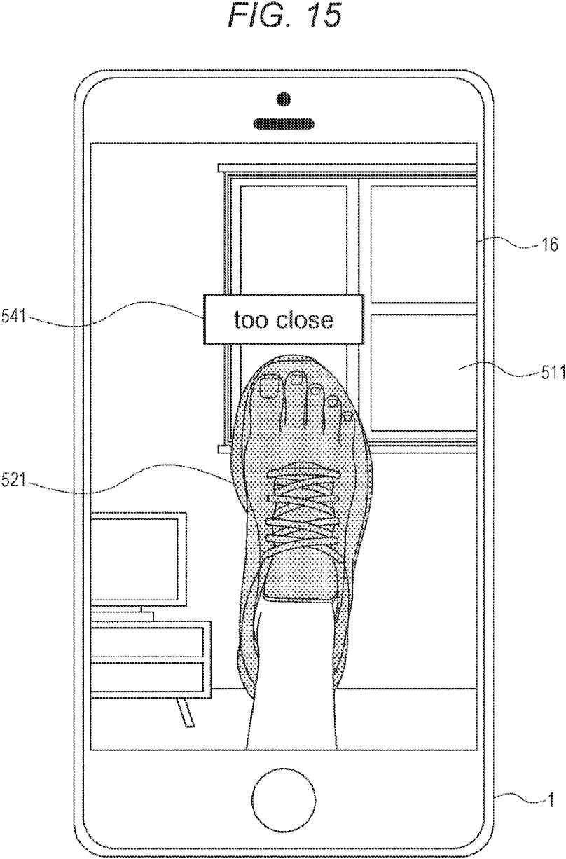

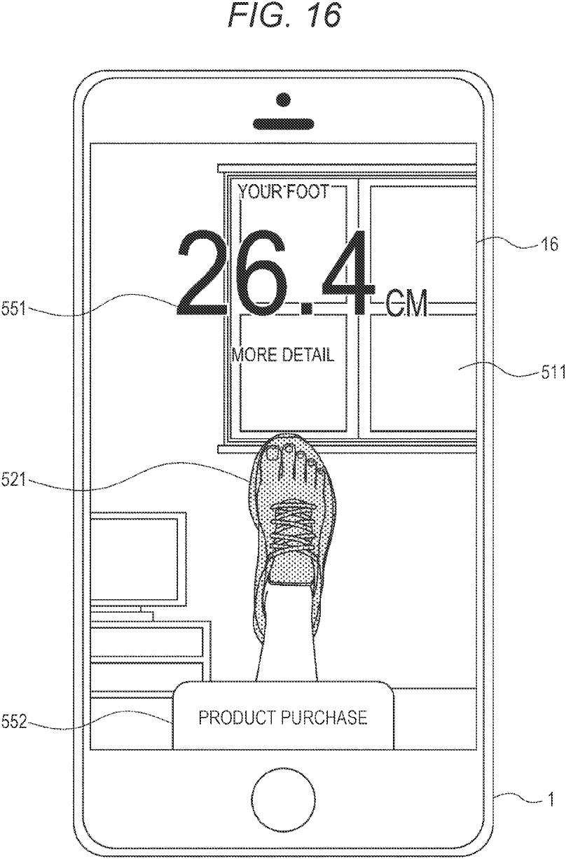

In a case where the position of the foot of the user with respect to the information processing device 1 is too close or too far, the processing unit 15 can display a message to that effect on the display unit 16 on the basis of information obtained by the foot length measuring process, information from other sensors, and the like. For example, as illustrated in FIG. 15, in a case where the position of the foot of the user is too close, a message 541 is displayed. By presenting the message, the user can be guided to a distance suitable for the foot length measurement by moving the information processing device 1, moving his/her foot, or the like.

Returning to FIG. 12, in step S115, the processing unit 15 determines whether the foot length measuring process has ended. In a case where it is determined in step S115 that the foot length measuring process has not ended, the process returns to step S113, steps S113 and S114 are repeated, and the progress status is displayed together with the AR image.

On the other hand, in a case where it is determined in step S115 that the foot length measuring process has ended, the process proceeds to step S116. In step S116, the processing unit 15 displays the foot size obtained by the foot length measuring process on the display unit 16. This foot size is a corrected foot size, and is corrected to a value measured in an ideal state, for example, if a joint of a toe of the user is in a bent state or the like at the time of imaging by the information processing device 1.

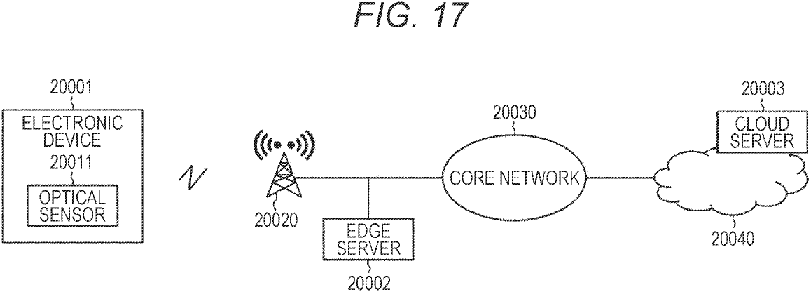

For example, as illustrated in FIG. 16, in the display unit 16 of the information processing device 1, the AR image 521 of the shoe is displayed in a superimposed manner on the imaging screen 511, and the foot size 551 is displayed. As a result, the user can recognize his/her foot size.

Returning to FIG. 12, in step S117, the processing unit 15 determines whether the user has selected the purchase of the shoe being tried on in AR on the basis of the operation signal from the operation unit 17.

In a case where it is determined in step S117 that the purchase of the shoe is selected, the process proceeds to step S118. In step S118, the processing unit 15 performs a product purchase process.

For example, as illustrated in FIG. 16, the display unit 16 of the information processing device 1 displays a button 552 for purchasing the shoes that have been tried on in the AR. In a case where the user desires to purchase the shoes that the user has tried on in the AR, the purchase screen is displayed by tapping the button 552. By performing a necessary operation on the purchase screen, the user can perform processing such as payment and purchase the shoes that have been tried on in the AR. On the purchase screen, it is possible to purchase shoes according to the foot size after correction obtained in the foot length measuring process, but the user who has confirmed the foot size 551 may be able to input or change the foot size of the user.

Note that the foot length measuring application may provide a function of performing AR try-on or purchasing of shoes of models similar to the selected shoes, not limited to the shoe selected by the user. Furthermore, in the foot length measuring application, the fit rate for each shoes may be calculated and displayed on the basis of information obtained in the foot length measuring process, information from other sensors, and the like. The user can check these pieces of information to determine whether to purchase the shoes.

Moreover, the information processing device 1 can access a server on the Internet, transmit the foot size after correction obtained in the foot length measuring process and the user information (gender, age, and the like), and request the confirmation of the shoes according to the characteristics of the user. The foot length measuring application can recommend the shoes according to the characteristics of the user on the basis of the response from the server.

When the process of step S118 ends, a series of processing ends. Furthermore, in a case where it is determined in step S117 that the purchase of the shoes is not selected, the process of step S118 is skipped, and the series of processing ends.

The flow of the shoe try-on purchase process has been described above. In the shoe try-on purchase process, a more accurate foot size is displayed to the user, and AR try-on and purchase of the target shoes are enabled. As a result, it is possible to increase the ratio at which the user purchases the target shoes.

### 6. Modification

### (Another Example of Size of Target)

In the above description, the foot size has been exemplified as the size of the target. However, in the information processing device 1, a length of another part of the body of the user may be measured, and an AR image of clothing, accessories, or the like may be displayed in a superimposed manner according to the measured part. Furthermore, the information processing device 1 may display the size of the measured part.

For example, by performing processing using the learned model on at least a part of the depth image obtained by imaging the user and the information obtained from the image, the shoulder width, the body width, and the like of the user are measured, and the AR image of the clothes is superimposed and displayed on the upper body portion of the user included in the RGB image simultaneously captured. Alternatively, by measuring the length around the finger of the user, the AR image of the ring is superimposed and displayed on the finger portion of the user included in the captured RGB image. Furthermore, the measured shoulder width, body width, length around the finger, and the like may be displayed together with the AR image of the clothes or the ring.

### (Rule Based Application)

In the above description, in the information processing device 1, the processing unit 15 performs processing using a learned model learned by machine learning, but some processing may be performed on a rule basis.

### (Another Configuration Example)

FIG. 17 illustrates a configuration example of a system including a device that performs AI processing.

An electronic device 20001 is a mobile terminal such as a smartphone, a tablet terminal, or a mobile phone. The electronic device 20001 corresponds to, for example, the information processing device 1 in FIG. 1, and includes an optical sensor 20011 corresponding to the depth sensor 11 (FIG. 1). The optical sensor is a sensor (image sensor) that converts light into an electric signal. The electronic device 20001 can be connected to a network 20040 such as the Internet via a core network 20030 by being connected to a base station 20020 installed at a predetermined place by wireless communication corresponding to a predetermined communication method.

At a location closer to the mobile terminal, such as between the base station 20020 and the core network 20030, an edge server 20002 is provided to implement mobile edge computing (MEC). A cloud server 20003 is connected to the network 20040. The edge server 20002 and the cloud server 20003 can perform various types of processing according to the purpose. Note that the edge server 20002 may be provided in the core network 20030.

AI processing is performed by the electronic device 20001, the edge server 20002, the cloud server 20003, or the optical sensor 20011. The AI processing is processing the technology according to the present disclosure using AI such as machine learning. The AI processing includes learning processing and inference processing. The learning processing is processing of generating a learned model. Furthermore, the learning processing also includes relearning processing to be described later. The inference processing is processing of performing inference using a learned model. The learned model can include at least one of the DNN 1 to the DNN 4 described above.

In the electronic device 20001, the edge server 20002, the cloud server 20003, or the optical sensor 20011, a processor such as a central processing unit (CPU) executes a program or dedicated hardware such as a processor specialized for a specific purpose is used to implement AI processing. For example, a graphics processing unit (GPU) can be used as a processor specialized for a specific purpose.

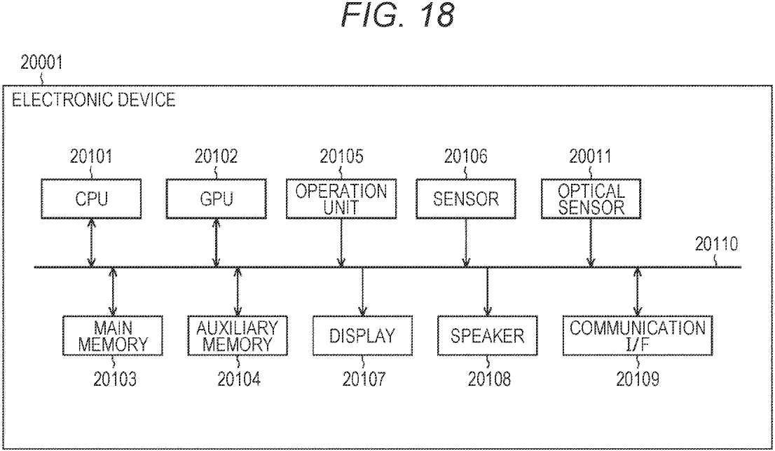

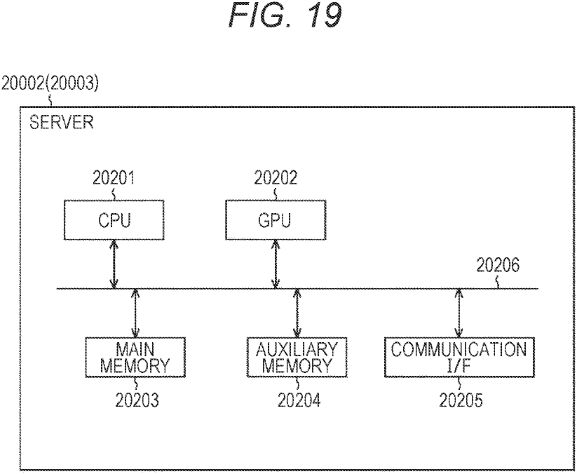

FIG. 18 illustrates a configuration example of the electronic device 20001. The electronic device 20001 includes a CPU 20101 that controls operation of each unit and performs various types of processing, a GPU 20102 specialized for image processing and parallel processing, a main memory 20103 such as a dynamic random access memory (DRAM), and an auxiliary memory 20104 such as a flash memory.

The auxiliary memory 20104 records programs for AI processing and data such as various parameters. The CPU 20101 loads the programs and parameters recorded in the auxiliary memory 20104 into the main memory 20103 and executes the programs. Alternatively, the CPU 20101 and the GPU 20102 develop programs and parameters recorded in the auxiliary memory 20104 in the main memory 20103 and execute the programs. As a result, the GPU 20102 can be used as a general-purpose computing on graphics processing units (GPGPU).

Note that the CPU 20101 and the GPU 20102 may be configured as a system on a chip (SoC). In a case where the CPU 20101 executes programs for AI processing, the GPU 20102 may not be provided.

The electronic device 20001 also includes the optical sensor 20011 to which the technology according to the present disclosure is applied, an operation unit 20105 such as a physical button or a touch panel, a sensor 20106 including at least one or more sensors, a display 20107 that displays information such as an image or text, a speaker 20108 that outputs sound, a communication I/F 20109 such as a communication module compatible with a predetermined communication method, and a bus 20110 that connects them.

The sensor 20106 includes at least one of various sensors such as an optical sensor (image sensor), a sound sensor (microphone), a vibration sensor, an acceleration sensor, an angular velocity sensor, a pressure sensor, an odor sensor, or a biometric sensor. In the AI processing, data acquired from at least one or more sensors of the sensor 20106 can be used together with data (image data) acquired from the optical sensor 20011. That is, the optical sensor 20011 corresponds to the depth sensor 11 (FIG. 1), and the sensor 20106 corresponds to the RGB sensor 13 (FIG. 1).

Note that data acquired from two or more optical sensors by the sensor fusion technology and data obtained by integrally processing the data may be used in the AI processing. As the two or more optical sensors, a combination of the optical sensor 20011 and the optical sensor in the sensor 20106 may be used, or a plurality of optical sensors may be included in the optical sensor 20011. For example, the optical sensor includes an RGB visible light sensor, a distance measuring sensor such as time of flight (ToF), a polarization sensor, an event-based sensor, a sensor that acquires an IR image, a sensor capable of acquiring multiple wavelengths, and the like.

In the electronic device 20001, AI processing can be performed by a processor such as the CPU 20101 or the GPU 20102. In a case where the processor of the electronic device 20001 performs the inference processing, since the processing can be started without requiring time after the image data is acquired by the optical sensor 20011, the processing can be performed at high speed. Therefore, in the electronic device 20001, when the inference processing is used for a purpose such as an application required to transmit information with a short delay time, the user can perform an operation without feeling uncomfortable due to the delay. Furthermore, in a case where the processor of the electronic device 20001 performs AI processing, it is not necessary to use a communication line, a computer device for a server, or the like, and the processing can be implemented at low cost, as compared with a case where a server such as the cloud server 20003 is used.

FIG. 19 illustrates a configuration example of the edge server 20002. The edge server 20002 includes a CPU 20201 that controls operation of each unit and performs various types of processing, and a GPU 20202 specialized for image processing and parallel processing. The edge server 20002 further includes a main memory 20203 such as a DRAM, an auxiliary memory 20204 such as a hard disk drive (HDD) or a solid state drive (SSD), and a communication I/F 20205 such as a network interface card (NIC), which are connected to the bus 20206.

The auxiliary memory 20204 records programs for AI processing and data such as various parameters. The CPU 20201 loads the programs and parameters recorded in the auxiliary memory 20204 into the main memory 20203 and executes the programs. Alternatively, the CPU 20201 and the GPU 20202 can develop programs or parameters recorded in the auxiliary memory 20204 in the main memory 20203 and execute the programs, whereby the GPU 20202 is used as a GPGPU. Note that, in a case where the CPU 20201 executes programs for AI processing, the GPU 20202 may not be provided.

In the edge server 20002, AI processing can be performed by a processor such as the CPU 20201 or the GPU 20202. In a case where the processor of the edge server 20002 performs the AI processing, since the edge server 20002 is provided at a position closer to the electronic device 20001 than the cloud server 20003, it is possible to realize low processing delay. Furthermore, the edge server 20002 has higher processing capability, such as a calculation speed, than the electronic device 20001 and the optical sensor 20011, and thus can be configured in a general-purpose manner. Therefore, in a case where the processor of the edge server 20002 performs the AI processing, the AI processing can be performed as long as data can be received regardless of a difference in specification or performance of the electronic device 20001 or the optical sensor 20011. In a case where the AI processing is performed by the edge server 20002, a processing load in the electronic device 20001 and the optical sensor 20011 can be reduced.

Since the configuration of the cloud server 20003 is similar to the configuration of the edge server 20002, the description thereof will be omitted.

In the cloud server 20003, AI processing can be performed by a processor such as the CPU 20201 or the GPU 20202. The cloud server 20003 has higher processing capability, such as calculation speed, than the electronic device 20001 and the optical sensor 20011, and thus can be configured in a general-purpose manner. Therefore, in a case where the processor of the cloud server 20003 performs the AI processing, the AI processing can be performed regardless of a difference in specifications and performance of the electronic device 20001 and the optical sensor 20011. Furthermore, in a case where it is difficult for the processor of the electronic device 20001 or the optical sensor 20011 to perform high-load AI processing, the processor of the cloud server 20003 can perform the high-load AI processing, and the processing result can be fed back to the processor of the electronic device 20001 or the optical sensor 20011.

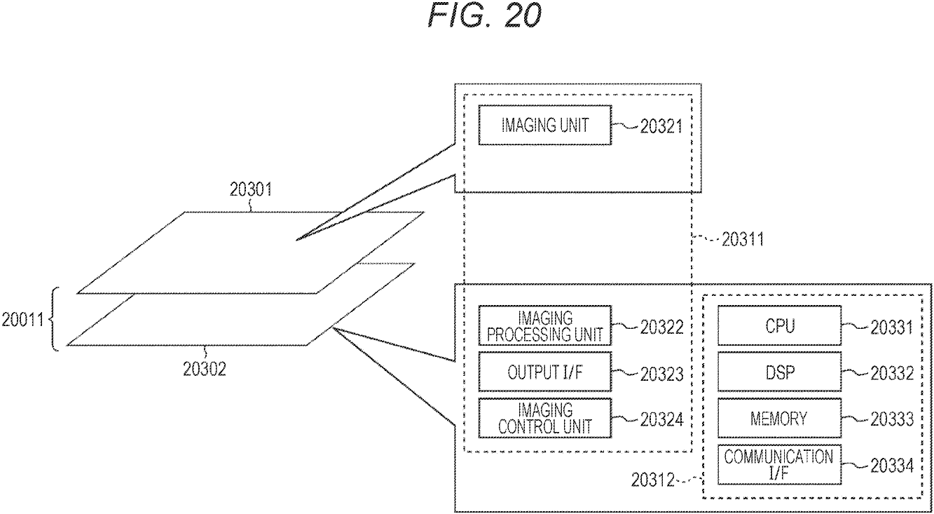

FIG. 20 illustrates a configuration example of the optical sensor 20011. The optical sensor 20011 can be configured as, for example, a one-chip semiconductor device having a stacked structure in which a plurality of substrates is stacked. The optical sensor 20011 is configured by stacking two substrates of a substrate 20301 and a substrate 20302. Note that the configuration of the optical sensor 20011 is not limited to the stacked structure, and for example, a substrate including an imaging unit may include a processor that performs AI processing such as a CPU or a digital signal processor (DSP).

An imaging unit 20321 including a plurality of pixels two-dimensionally arranged is mounted on the upper substrate 20301. An imaging processing unit 20322 that performs processing related to imaging of an image by the imaging unit 20321, an output I/F 20323 that outputs a captured image and a signal processing result to the outside, and an imaging control unit 20324 that controls imaging of an image by the imaging unit 20321 are mounted on the lower substrate 20302. The imaging unit 20321, the imaging processing unit 20322, the output I/F 20323, and the imaging control unit 20324 constitute an imaging block 20311.

A CPU 20331 that performs control of each unit and various types of processing, a DSP 20332 that performs signal processing using a captured image, information from the outside, and the like, a memory 20333 such as a static random access memory (SRAM) or a dynamic random access memory (DRAM), and a communication I/F 20334 that exchanges necessary information with the outside are mounted on the lower substrate 20302. The CPU 20331, the DSP 20332, the memory 20333, and the communication I/F 20334 constitute a signal processing block 20312. AI processing can be performed by at least one processor of the CPU 20331 or the DSP 20332.

As described above, the signal processing block 20312 for AI processing can be mounted on the lower substrate 20302 in the stacked structure in which the plurality of substrates is stacked. As a result, the image data acquired by the imaging block 20311 for imaging mounted on the upper substrate 20301 is processed by the signal processing block 20312 for AI processing mounted on the lower substrate 20302, so that a series of processing can be performed in the one-chip semiconductor device.

In the optical sensor 20011, AI processing can be performed by a processor such as the CPU 20331. In a case where the processor of the optical sensor 20011 performs AI processing such as inference processing, since a series of processing is performed in a one-chip semiconductor device, information does not leak to the outside of the sensor, and thus, it is possible to enhance confidentiality of the information. Furthermore, since it is not necessary to transmit data such as image data to another device, the processor of the optical sensor 20011 can perform AI processing such as inference processing using the image data at high speed. For example, when inference processing is used for a purpose such as an application requiring a real-time property, it is possible to sufficiently secure the real-time property. Here, securing the real-time property means that information can be transmitted with a short delay time. Moreover, when the processor of the optical sensor 20011 performs the AI processing, various kinds of metadata are passed by the processor of the electronic device 20001, so that the processing can be reduced and the power consumption can be reduced.

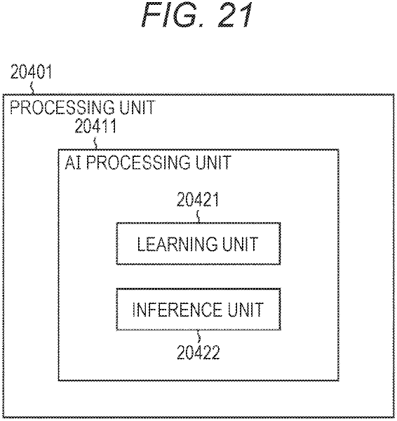

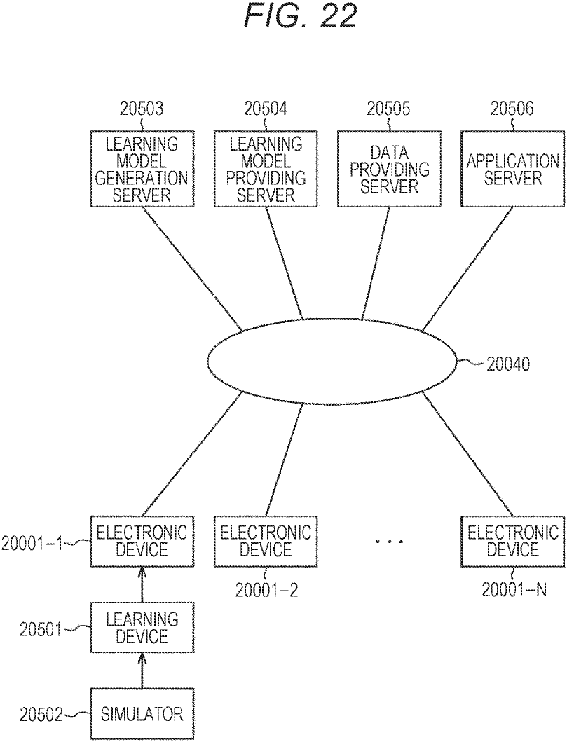

FIG. 21 illustrates a configuration example of a processing unit 20401. The processing unit 20401 corresponds to the processing unit 10 in FIG. 1. A processor of the electronic device 20001, the edge server 20002, the cloud server 20003, or the optical sensor 20011 executes various types of processing according to a program, thereby functioning as the processing unit 20401. Note that a plurality of processors included in the same or different devices may function as the processing unit 20401.

The processing unit 20401 includes an AI processing unit 20411. The AI processing unit 20411 performs AI processing. The AI processing unit 20411 includes a learning unit 20421 and an inference unit 20422.

The learning unit 20421 performs learning processing of generating a learned model. In the learning processing, a learned model such as the DNN 1 to the DNN 4 is generated. Furthermore, the learning unit 20421 may perform relearning processing of updating the generated learned model. In the following description, generation and update of the learned model will be described separately, but since it can be said that the learned model is generated by updating the learned model, the generation of the learned model includes the meaning of the update of the learned model.

Furthermore, the generated learned model is recorded in a storage medium such as a main memory or an auxiliary memory included in the electronic device 20001, the edge server 20002, the cloud server 20003, the optical sensor 20011, or the like, and thus, can be newly used in the inference processing performed by the inference unit 20422. As a result, the electronic device 20001, the edge server 20002, the cloud server 20003, the optical sensor 20011, or the like that performs inference processing based on the learned model can be generated. Moreover, the generated learned model may be recorded in a storage medium or electronic device independent of the electronic device 20001, the edge server 20002, the cloud server 20003, the optical sensor 20011, or the like, and provided for use in other devices. Note that the generation of the electronic device 20001, the edge server 20002, the cloud server 20003, the optical sensor 20011, or the like includes not only newly recording the learned model in the storage medium at the time of manufacturing but also updating the already recorded generated learned model.

The inference unit 20422 performs inference processing using the learned model. In the inference processing, processing using a learned model such as the DNN 1 to the DNN 4 is performed.

As a method of machine learning, a neural network, deep learning, or the like can be used. The neural network is a model imitating a human cranial nerve circuit, and includes three types of layers of an input layer, an intermediate layer (hidden layer), and an output layer. Deep learning is a model using a neural network having a multilayer structure, and can learn a complex pattern hidden in a large amount of data by repeating characteristic learning in each layer.

Supervised learning can be used as the problem setting of the machine learning. For example, supervised learning learns a feature amount on the basis of given labeled teacher data. As a result, it is possible to derive a label of unknown data. As the learning data, image data actually acquired by the optical sensor, acquired image data aggregated and managed, a data set generated by the simulator, and the like can be used.

Note that not only supervised learning but also unsupervised learning, semi-supervised learning, reinforcement learning, and the like may be used. In the unsupervised learning, a large amount of unlabeled learning data is analyzed to extract a feature amount, and clustering or the like is performed on the basis of the extracted feature amount. As a result, it is possible to analyze and predict the tendency on the basis of a huge amount of unknown data. The semi-supervised learning is a method in which supervised learning and unsupervised learning are mixed, and is a method in which a feature amount is learned by the supervised learning, then a huge amount of learning data is given by the unsupervised learning, and repetitive learning is performed while the feature amount is automatically calculated. The reinforcement learning deals with a problem of determining an action that an agent in a certain environment should take by observing a current state.

As described above, the processor of the electronic device 20001, the edge server 20002, the cloud server 20003, or the optical sensor 20011 functions as the AI processing unit 20411, so that the AI processing is performed by any one or a plurality of devices.

The AI processing unit 20411 only needs to include at least one of the learning unit 20421 or the inference unit 20422. That is, the processor of each device may execute one of the learning processing or the inference processing as well as execute both the learning processing and the inference processing. For example, in a case where the processor of the electronic device 20001 performs both the inference processing and the learning processing, the learning unit 20421 and the inference unit 20422 are included, but in a case where only the inference processing is performed, only the inference unit 20422 may be included.

The processor of each device may execute all processes related to the learning processing or the inference processing, or may execute some processes by the processor of each device and then execute the remaining processes by the processor of another device. Furthermore, each device may have a common processor for executing each function of AI processing such as learning processing or inference processing, or may have a processor individually for each function.

Note that the AI processing may be performed by a device other than the above-described devices. For example, AI processing can be performed by another electronic device to which the electronic device 20001 can be connected by wireless communication or the like. Specifically, in a case where the electronic device 20001 is a smartphone, the other electronic device that performs the AI processing can be a device such as another smartphone, a tablet terminal, a mobile phone, a personal computer (PC), a game machine, a television receiver, a wearable terminal, a digital still camera, or a digital video camera.

Furthermore, even in a configuration using a sensor mounted on a moving body such as an automobile, a sensor used in a remote medical device, or the like, AI processing such as inference processing can be applied, but a delay time is required to be short in these environments. In such an environment, the delay time can be shortened by not performing the AI processing by the processor of the cloud server 20003 via the network 20040 but performing the AI processing by the processor of the local-side device (for example, the electronic device 20001 as the in-vehicle device or the medical device). Moreover, even in a case where there is no environment to connect to the network 20040 such as the Internet or in a case of a device used in an environment in which high-speed connection cannot be performed, AI processing can be performed in a more appropriate environment by performing AI processing by the processor of the local-side device such as the electronic device 20001 or the optical sensor 20011, for example.

Note that the above-described configuration is an example, and other configurations may be adopted. For example, the electronic device 20001 is not limited to a mobile terminal such as a smartphone, and may be an electronic device such as a PC, a game machine, a television receiver, a wearable terminal, a digital still camera, or a digital video camera, an in-vehicle device, or a medical device. Furthermore, the electronic device 20001 may be connected to the network 20040 by wireless communication or wired communication corresponding to a predetermined communication method such as a wireless local area network (LAN) or a wired LAN. The AI processing is not limited to a processor such as a CPU or a GPU of each device, and a quantum computer, a neuromorphic computer, or the like may be used.

Incidentally, the data such as the learned model, the image data, and the corrected data may be used in a single device or may be exchanged between a plurality of devices and used in those devices. FIG. 22 illustrates a flow of data between a plurality of devices.

Electronic devices 20001-1 to 20001-N (N is an integer of 1 or more) are possessed by each user, for example, and can be connected to the network 20040 such as the Internet via a base station (not illustrated) or the like. At the time of manufacturing, a learning device 20501 is connected to the electronic device 20001-1, and the learned model provided by the learning device 20501 can be recorded in the auxiliary memory 20104. The learning device 20501 generates a learned model by using a data set generated by a simulator 20502 as learning data and provides the learned model to the electronic device 20001-1. Note that the learning data is not limited to the data set provided from the simulator 20502, and image data actually acquired by the optical sensor, acquired image data aggregated and managed, or the like may be used.

Although not illustrated, the learned model can be recorded in the electronic devices 20001-2 to 20001-N at the stage of manufacturing, similarly to the electronic device 20001-1. Hereinafter, the electronic devices 20001-1 to 20001-N will be referred to as electronic devices 20001 in a case where it is not necessary to distinguish the electronic devices from each other.

In addition to the electronic device 20001, a learning model generation server 20503, a learning model providing server 20504, a data providing server 20505, and an application server 20506 are connected to the network 20040, and can exchange data with each other. Each server can be provided as a cloud server.

The learning model generation server 20503 has a configuration similar to that of the cloud server 20003, and can perform learning processing by a processor such as a CPU. The learning model generation server 20503 generates a learned model using the learning data. In the illustrated configuration, the case where the electronic device 20001 records the learned model at the time of manufacturing is exemplified, but the learned model may be provided from the learning model generation server 20503. The learning model generation server 20503 transmits the generated learned model to the electronic device 20001 via the network 20040. The electronic device 20001 receives the learned model transmitted from the learning model generation server 20503 and records the learned model in the auxiliary memory 20104. As a result, the electronic device 20001 including the learned model is generated.

That is, in the electronic device 20001, in a case where the learned model is not recorded at the stage of manufacturing, the electronic device 20001 recording the new learned model is generated by newly recording the learned model from the learning model generation server 20503. Furthermore, in the electronic device 20001, in a case where the learned model has already been recorded at the stage of manufacturing, the electronic device 20001 recording the updated learned model is generated by updating the recorded learned model to the learned model from the learning model generation server 20503. The electronic device 20001 can perform inference processing using a learned model that is appropriately updated.

The learned model is not limited to being directly provided from the learning model generation server 20503 to the electronic device 20001, and may be provided by the learning model providing server 20504 that aggregates and manages various learned models via the network 20040. The learning model providing server 20504 may generate another device including a learned model by providing the learned model to the other device, not limited to the electronic device 20001. Furthermore, the learned model may be provided by being recorded in a detachable memory card such as a flash memory. The electronic device 20001 can read and record the learned model from the memory card attached to the slot. As a result, the electronic device 20001 can acquire the learned model even in a case where the electronic device is used in a severe environment, in a case where the electronic device does not have a communication function, in a case where the electronic device has a communication function but the amount of information that can be transmitted is small, or the like.

The electronic device 20001 can provide data such as image data, corrected data, and metadata to other devices via the network 20040. For example, the electronic device 20001 transmits data such as image data and corrected data to the learning model generation server 20503 via the network 20040. As a result, the learning model generation server 20503 can generate a learned model using data such as image data or corrected data collected from one or a plurality of electronic devices 20001 as learning data. By using more learning data, the accuracy of the learning processing can be improved.

The data such as the image data and the corrected data is not limited to be directly provided from the electronic device 20001 to the learning model generation server 20503, and may be provided by the data providing server 20505 that aggregates and manages various data. The data providing server 20505 may collect data from not only the electronic device 20001 but also another device, or may provide data to not only the learning model generation server 20503 but also another device.

The learning model generation server 20503 may perform relearning processing of adding data such as image data and corrected data provided from the electronic device 20001 or the data providing server 20505 to the learning data on the already-generated learned model to update the learned model. The updated learned model can be provided to the electronic device 20001. In a case where learning processing or relearning processing is performed in the learning model generation server 20503, processing can be performed regardless of a difference in specification or performance of the electronic device 20001.

Furthermore, in the electronic device 20001, in a case where the user performs a correction operation on the corrected data or the metadata (for example, in a case where the user inputs correct information), the feedback data regarding the correction processing may be used for the relearning processing. For example, by transmitting the feedback data from the electronic device 20001 to the learning model generation server 20503, the learning model generation server 20503 can perform relearning processing using the feedback data from the electronic device 20001 and update the learned model. Note that, in the electronic device 20001, an application provided by the application server 20506 may be used when the user performs a correction operation.

The relearning processing may be performed by the electronic device 20001. In a case where the electronic device 20001 updates the learned model by performing the relearning processing using the image data or the feedback data, the learned model can be improved in the device. As a result, the electronic device 20001 including the updated learned model is generated. Furthermore, the electronic device 20001 may transmit the learned model after update obtained by the relearning processing to the learning model providing server 20504 so as to be provided to another electronic device 20001. As a result, the learned model after the update can be shared among the plurality of electronic devices 20001.

Alternatively, the electronic device 20001 may transmit difference information of the relearned learned model (difference information regarding the learned model before update and the learned model after update) to the learning model generation server 20503 as update information. The learning model generation server 20503 can generate an improved learned model on the basis of the update information from the electronic device 20001 and provide the improved learned model to another electronic device 20001. By exchanging such difference information, privacy can be protected and communication cost can be reduced as compared with a case where all information is exchanged. Note that, similarly to the electronic device 20001, the optical sensor 20011 mounted on the electronic device 20001 may perform the relearning processing.

The application server 20506 is a server capable of providing various applications via the network 20040. An application provides a predetermined function using data such as a learned model, corrected data, or metadata. The electronic device 20001 can implement a predetermined function by executing an application downloaded from the application server 20506 via the network 20040. Alternatively, the application server 20506 can also implement a predetermined function by acquiring data from the electronic device 20001 via, for example, an application programming interface (API) or the like and executing an application on the application server 20506.

As described above, in a system including a device to which the present disclosure is applied, data such as a learned model, image data, and corrected data is exchanged and distributed among the devices, and various services using the data can be provided. For example, it is possible to provide a service for providing a learned model via the learning model providing server 20504 and a service for providing data such as image data and corrected data via the data providing server 20505. Furthermore, it is possible to provide a service for providing an application via the application server 20506.

Alternatively, the image data acquired from the optical sensor 20011 of the electronic device 20001 may be input to the learned model provided by the learning model providing server 20504, and corrected data obtained as an output thereof may be provided. Furthermore, a device such as an electronic device on which the learned model provided by the learning model providing server 20504 is equipped may be generated and provided. Moreover, by recording data such as the learned model, the corrected data, and the metadata in a readable storage medium, a device such as a storage medium in which the data is recorded or an electronic device on which the storage medium is mounted may be generated and provided. The storage medium may be a nonvolatile memory such as a magnetic disk, an optical disk, a magneto-optical disk, or a semiconductor memory, or may be a volatile memory such as an SRAM or a DRAM.

Note that the embodiments of the present disclosure are not limited to the above-described embodiments, and various modifications can be made without departing from the gist of the present disclosure. Furthermore, the effects described in the present specification are merely examples and are not limited, and other effects may be provided. Note that, in the present specification, “2D” represents two dimensions, and “3D” represents three dimensions.

Furthermore, the present disclosure can have the following configurations.
(1) An information processing device including
   a processing unit that performs processing using a learned model learned by machine learning on at least a part of an image including at least a depth image acquired by a sensor and information obtained from the image, and measures a size of a target included in the image.
(2) The information processing device according to (1),
   in which the learned model is a deep neural network learned using at least one of the image or the information as an input and the size of the target as an output.
(3) The information processing device according to (2),
   in which the learned model includes:
      a first learned model using the image as an input and a feature point of the target as an output; and
      a second learned model using the feature point of the target, the size of the target, and a posture of the target as inputs and a corrected size obtained by correcting the size of the target as an output.
(4) The information processing device according to (3),
   in which the second learned model uses user information regarding the target as an input together with the feature point of the target, the size of the target, and the posture of the target, and uses the corrected size as an output.
(5) The information processing device according to (3) or (4),
   in which the processing unit
   calculates the size of the target and the posture of the target on the basis of the feature point of the target output from the first learned model, and
   inputs the size of the target and the posture of the target calculated to the second learned model.
(6) The information processing device according to any one of (3) to (5),
   in which the first learned model outputs a 2D feature point or a 3D feature point as the feature point, and
   the second learned model inputs a 3D feature point as the feature point.
(7) The information processing device according to (6),
   in which in a case where the feature point is the 2D feature point, the processing unit calculates the 3D feature point from the 2D feature point.
(8) The information processing device according to any one of (3) to (7), further including
   a display unit that displays the corrected size.
   in which the display unit superimposes and displays an AR image on a part corresponding to the target included in a captured image obtained by capturing a user.
(10) The information processing device according to any one of (1) to (9),
   in which the target is a foot of a user, and
   the size of the target is a size of the foot of the user.
(11) The information processing device according to any one of (1) to (10),
   in which the image further includes an RGB image.
(12) The information processing device according to any one of (1) to (11),
   in which the information processing device is configured as a mobile terminal including the sensor, the processing unit, and the display unit that displays a processing result by the processing unit.
(13) An information processing method
   in which an information processing device
   performs processing using a learned model learned by machine learning on at least a part of an image including at least a depth image acquired by a sensor and information obtained from the image, and measures a size of a target included in the image.
(14) A program for causing a computer to function as an information processing device including
   a processing unit that performs processing using a learned model learned by machine learning on at least a part of an image including at least a depth image acquired by a sensor and information obtained from the image, and measures a size of a target included in the image.

| | REFERENCE SIGNS LIST |
|---|---|
| 1 | Information processing device |
| 2 | Information processing device |
| 3 | Imaging device |
| 4 | Database |
| 11 | Depth sensor |
| 12 | Depth processing unit |
| 13 | RGB sensor |
| 14 | RGB processing unit |
| 15, 15A, 15B, 15C | Processing unit |
| 16 | Display unit |
| 17 | Operation unit |
| 111 | Learned model |
| 112 | 3D coordinate calculation unit |
| 113 | Foot size and posture calculation unit |
| 114 | Learned model |
| 211 | Learned model |
| 311 | Learned model |

What is claimed is:

1. An information processing device comprising
a processing unit that performs processing using a learned model learned by machine learning on at least a part of an image including at least a depth image acquired by a sensor and information obtained from the image, and measures a size of a target included in the image.

2. The information processing device according to claim 1,
wherein the learned model is a deep neural network learned using at least one of the image or the information as an input and the size of the target as an output.

3. The information processing device according to claim 2,
wherein the learned model includes:
a first learned model using the image as an input and a feature point of the target as an output; and
a second learned model using the feature point of the target, the size of the target, and a posture of the target as inputs and a corrected size obtained by correcting the size of the target as an output.

4. The information processing device according to claim 3,
wherein the second learned model uses user information regarding the target as an input together with the feature point of the target, the size of the target, and the posture of the target, and uses the corrected size as an output.

5. The information processing device according to claim 3,
wherein the processing unit
calculates the size of the target and the posture of the target on a basis of the feature point of the target output from the first learned model, and
inputs the size of the target and the posture of the target calculated to the second learned model.

6. The information processing device according to claim 3,
wherein the first learned model outputs a 2D feature point or a 3D feature point as the feature point, and
the second learned model inputs a 3D feature point as the feature point.

7. The information processing device according to claim 6,
wherein in a case where the feature point is the 2D feature point, the processing unit calculates the 3D feature point from the 2D feature point.

8. The information processing device according to claim 3, further comprising
a display unit that displays the corrected size.

9. The information processing device according to claim 8,
wherein the display unit superimposes and displays an AR image on a part corresponding to the target included in a captured image obtained by capturing a user.

10. The information processing device according to claim 1,
wherein the target is a foot of a user, and
the size of the target is a size of the foot of the user.

11. The information processing device according to claim 1,
wherein the image further includes an RGB image.

12. The information processing device according to claim 8,
wherein the information processing device is configured as a mobile terminal including the sensor, the processing unit, and the display unit.

13. An information processing method
wherein an information processing device
performs processing using a learned model learned by machine learning on at least a part of an image including at least a depth image acquired by a sensor and information obtained from the image, and measures a size of a target included in the image.

14. A program for causing a computer to function as an information processing device comprising
a processing unit that performs processing using a learned model learned by machine learning on at least a part of an image including at least a depth image acquired by a sensor and information obtained from the image, and measures a size of a target included in the image.
